(19) United States
(12) Patent Application Publication
(10) Pub. No.: US 2025/0238748 A1
(43) Pub. Date: Jul. 24, 2025

(54) SYSTEMS AND METHODS FOR ADVANCED ALGORITHMIC COMPLIANCE INTEGRATION IN API FRAMEWORKS

(71) Applicant: BANK OF AMERICA CORPORATION, Charlotte, NC (US)

(72) Inventors: Amer Ali, Jersey City, NJ (US); Pratap Dande, Saint Johns, FL (US); Sailesh Vezzu, Hillsborough, NJ (US); Rahul Shashidhar Phadnis, Charlotte, NC (US); Rahul Yaksh, Austin, TX (US); Hari Vuppala, Concord, NC (US); Elvis Nyamwange, Little Elm, TX (US); Brian Neal Jacobson, Los Angeles, CA (US); Erik Dahl, Newark, DE (US)

(73) Assignee: BANK OF AMERICA CORPORATION, Charlotte, NC (US)

(21) Appl. No.: 18/416,816

(22) Filed: Jan. 18, 2024

(51) Int. Cl. G06Q 10/0637; G06F 40/20

(52) U.S. Cl. CPC G06Q 10/06375; G06F 40/20

(57) ABSTRACT

Systems, computer program products, and methods are described herein for advanced algorithmic compliance integration in API frameworks. The present disclosure is configured to retrieve data from multiple sources via a data acquisition engine, encompassing subsets of regulatory text and public sentiment data. It standardizes and preprocesses this data, generating structured analysis data. A machine learning engine performs sentiment analysis on the public sentiment data subset. Based on this analysis, it calculates a sentiment alignment score, represented as a percentage value, reflecting the alignment between the regulatory text data and public sentiment data. The system further retrieves updated and historical regulatory text data, analyzing them to determine changes in requirements. It then generates recommendations for API data handling practices, incorporating both the sentiment alignment score and identified requirement changes. This system enhances compliance management in API frameworks, integrating real-time data analysis and predictive compliance strategies.

### TECHNOLOGICAL FIELD

Example embodiments of the present disclosure relate to advanced algorithmic compliance integration in API frameworks.

### BACKGROUND

In the context of the digital transformation era, the integration and utilization of Application Programming Interfaces (APIs) have become increasingly critical. APIs serve as the building blocks for various digital services and applications, enabling seamless data exchange and interaction between different systems and platforms. Various entities and industries handle data that is complex and sensitive in nature, which requires stringent adherence to standards and requirements to maintain trust and integrity. Challenges lie in the dynamic and diverse nature of these requirements, which vary significantly across different entities or geographic regions. Moreover, the interpretation of standards in the digital realm, particularly in the use of APIs, adds another layer of complexity. Traditional methods of ensuring compliance, largely manual, are becoming obsolete and impractical in the face of rapid technological advancements and the continuous evolution of frameworks. The intricate interplay of these factors results in a high chance of non-compliance, which could lead to serious reputational repercussions for entities. Thus, there is an emerging need for innovative, automated solutions that can adeptly navigate and conform to these evolving standards, ensuring that API offerings in any sector remain compliant.

Applicant has identified a number of deficiencies and problems associated with the current approaches to ensuring API compliance. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for advanced algorithmic compliance integration in API frameworks.

The present disclosure introduces an innovative solution involving a comprehensive system that revolutionizes compliance in various sector API frameworks. This AI-driven system is engineered to monitor, analyze, and ensure adherence to the latest standards and regulatory requirements specific to APIs. By leveraging state-of-the-art artificial intelligence algorithms, the system integrates real-time data feeds from various regulatory bodies and guideline repositories. This integration allows for dynamic and continuous assessment of APIs against the current regulatory landscape and norms. The capabilities extend beyond mere compliance checking; it proactively identifies potential non-compliance issues, offers insights for remediation, and adapts to evolving regulations and standards. This ensures that entities can confidently rely on their API offerings to be compliant, reducing the chance of legal and financial consequences and maintaining reputational integrity. The system represents a significant leap forward in managing the complexities of API compliance, providing a robust, automated, and intelligent solution to a previously manual and error-prone process.

Embodiments of the invention relate to systems, methods, and computer program products for advanced algorithmic compliance integration in API frameworks, the invention generally including the steps of: retrieve, via data acquisition engine, data from multiple sources, wherein the data comprises a subset of regulatory text data and a subset of public sentiment data; standardize and preprocess the data, generating structured analysis data; perform, via a machine learning engine, a sentiment analysis on the subset of public sentiment data; based on the sentiment analysis, calculate a sentiment alignment score, wherein the sentiment alignment score comprises a percentage value representing alignment between the subset of regulatory test data and the subset of public sentiment data; retrieve, via the data acquisition engine, updated regulatory text data and historical regulatory text data; analyze, via the machine learning engine, the updated regulatory text data and the historical regulatory text data and determine a change to a requirement; and generate a recommendation for an API data handling practice based on both the sentiment alignment score and the change to the requirement.

In some embodiments, the data acquisition engine comprises a stream processing engine for continuous data processing and a batch data warehouse for scheduled data transfer.

In some embodiments, the standardizing and the preprocessing of data further comprises data normalization, entity extraction, and thematic analysis.

In some embodiments, the sentiment analysis and the calculation of sentiment alignment score are performed using Natural Language Processing (NLP) libraries.

In some embodiments, the system is further configured to identify a most stringent standard between multiple regions; and generate a recommendation for the API data handling practice aligning with the most stringent standard.

In some embodiments, the recommendation for the API data handling practice further comprises updating an API compliance check module and adjusting an API data handling rule.

In some embodiments, the system is further configured to transmit the recommendation for the API data handling practice via an interactive dashboard displaying one or more compliance insights.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for advanced algorithmic compliance integration in API frameworks, in accordance with an embodiment of the disclosure;

FIG. 2 illustrates an exemplary machine learning (ML) subsystem architecture 200, in accordance with an embodiment of the invention; and

FIG. 3 illustrates a process flow for advanced algorithmic compliance integration in API frameworks, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “artificial intelligence” (AI) refers to a broad domain of computer science that emphasizes the creation of intelligent machines capable of performing tasks that typically require human intelligence. These tasks may include, but are not limited to, learning, problem solving, perception, decision-making, and language understanding. In the context of this invention, AI may be utilized to interpret and analyze complex regulatory requirements and guidelines. This interpretation and analysis involve processing large volumes of data, recognizing patterns, and making informed decisions or predictions based on this data. By employing AI, the system can automate the process of monitoring and ensuring compliance with current regulations and standards, thus significantly reducing manual effort and increasing efficiency and accuracy.

As used herein, “machine learning” is a subset of artificial intelligence that involves the use of statistical techniques to enable computers to improve at tasks with experience. Essentially, machine learning focuses on the development of algorithms that can learn from and make predictions or decisions based on data. In the application of this invention, machine learning algorithms can be utilized to continuously adapt and update the compliance criteria based on evolving regulations and guidelines. This learning process allows the system to stay abreast of changes and nuances in regulatory requirements across different jurisdictions and sectors, ensuring that entities' API offerings remain compliant over time. The machine learning component of the system is particularly crucial for its capability to evolve its understanding and response to new regulatory challenges and considerations in the various sectors.

As used herein, a “sentiment alignment score” is a metric used to quantify the degree of alignment between public sentiment and specific regulatory changes or laws. This score helps in determining how closely the public opinion mirrors the principles or requirements of a particular regulation. As such the sentiment alignment score may be a numerical value representing the extent to which public sentiment, as gathered from various data sources like social media, news articles, and forums, aligns with the regulatory language or stipulations of a law. This score is derived from analyzing sentiment data against the specifics of a regulation. For instance, considering a new data protection law that mandates stricter data consent requirements, the sentiment alignment score would measure how the public's opinion on data consent aligns with these new legal stipulations. The score could be represented as a percentage, where 100% indicates perfect alignment (public opinion fully supports the regulation), and lower percentages indicate lesser degrees of alignment. In an example metric, if the analysis reveals that 80% of the sentiment data reflects a positive view towards stricter data consent, the sentiment alignment score would be 80%. While the sentiment alignment score could vary in its representation (like using R values or other statistical measures), a preferred embodiment in the system is the percentage scale. This is due to its intuitive nature, making it easily understandable for end users. A percentage scale offers a clear and direct interpretation of how well public opinion agrees with the regulation, thus aiding in making informed decisions about aligning business practices or API management strategies with prevailing public sentiments and regulatory standards. In this way, the sentiment alignment score serves as a crucial tool within the system, guiding entities to not only comply with legal requirements but also align their data handling practices with public expectations.

The technology introduced herein aims at significantly improving the way entities manage and ensure compliance with data privacy regulations and standards, particularly in the field of API data usage and collection. This innovation harnesses the power of artificial intelligence and machine learning to automate and enhance the compliance processes. The problem in the field is multifaceted: the landscape of data privacy laws is rapidly evolving, and public sentiment towards data handling practices is increasingly influential. Entities face the challenging task of staying compliant with the complex web of global regulations, and failure to do so can result in severe consequences such as loss of customer trust, and significant reputational damage.

Accordingly, the present disclosure outlines a system that automates the monitoring and analysis of legal and public sentiment data to provide real-time compliance and standards recommendations. This system integrates seamlessly with an entity's existing API framework, offering a streamlined, efficient approach to data privacy management. It not only stays current with the latest regulations but also anticipates future changes, thereby maintaining an entity's reputation for data stewardship.

What is more, the present disclosure provides a technical solution to a technical problem. As described herein, the technical problem includes the cumbersome, error-prone process of manual compliance checks against constantly changing international data privacy laws and the diverse and evolving nature of public sentiment towards data handling practices. The technical solution presented herein allows for automated, real-time analysis and compliance checks using artificial intelligence, significantly reducing the human error associated with manual processes. In particular, this solution is an improvement over existing solutions to the compliance problem by (i) reducing the steps required to maintain compliance, thereby minimizing the use of computing resources, (ii) enhancing the accuracy of compliance monitoring, thereby decreasing the resources needed to correct compliance-related errors, (iii) eliminating manual processes, thus increasing the speed and efficiency of compliance checks and conserving computational resources, (iv) calculating the optimal amount of resources required for compliance maintenance, thereby reducing network traffic and the load on computing systems. Furthermore, the technical solution described herein uses a rigorous, computerized process to perform specific tasks and activities that were not previously performed in an automated fashion. In specific implementations, the technical solution bypasses a series of steps previously implemented, thus further conserving computing resources and providing a cutting-edge approach to regulatory compliance and data management.

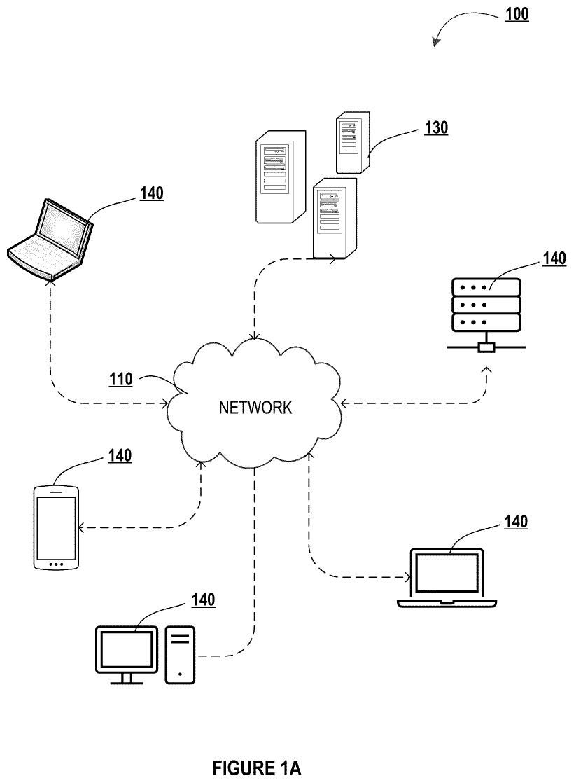

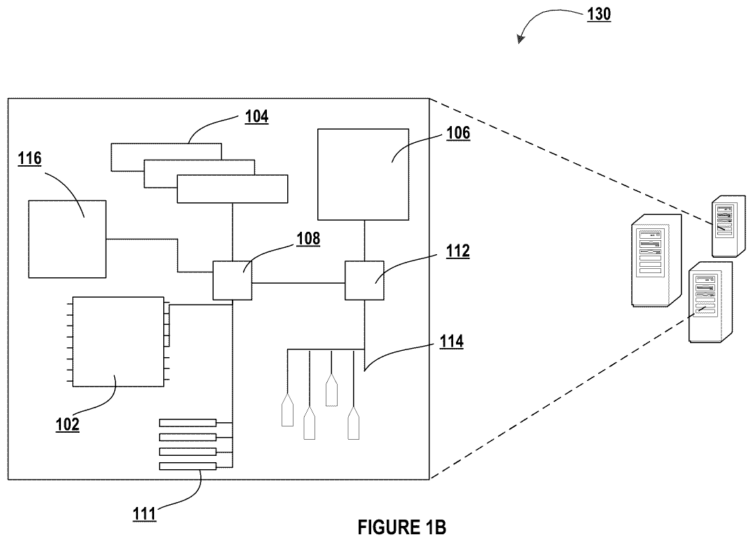

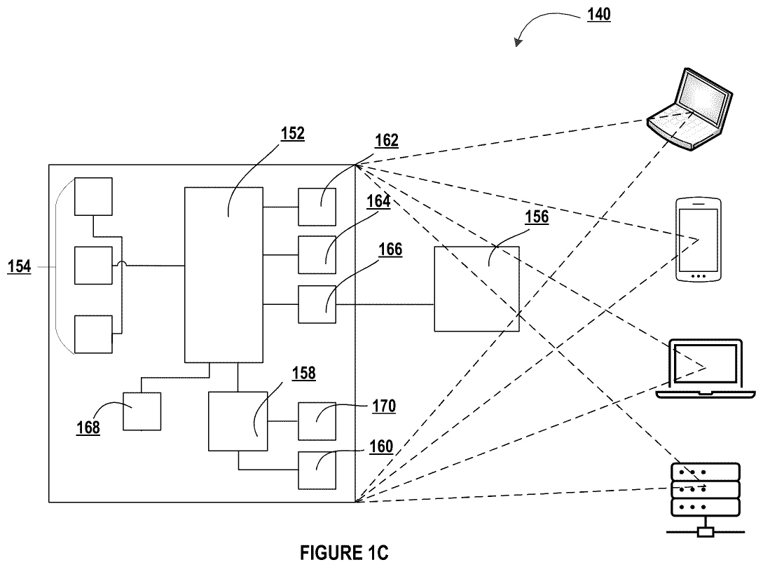

FIGS. 1A-1C illustrate technical components of an exemplary distributed computing environment 100 for advanced algorithmic compliance integration in API frameworks, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

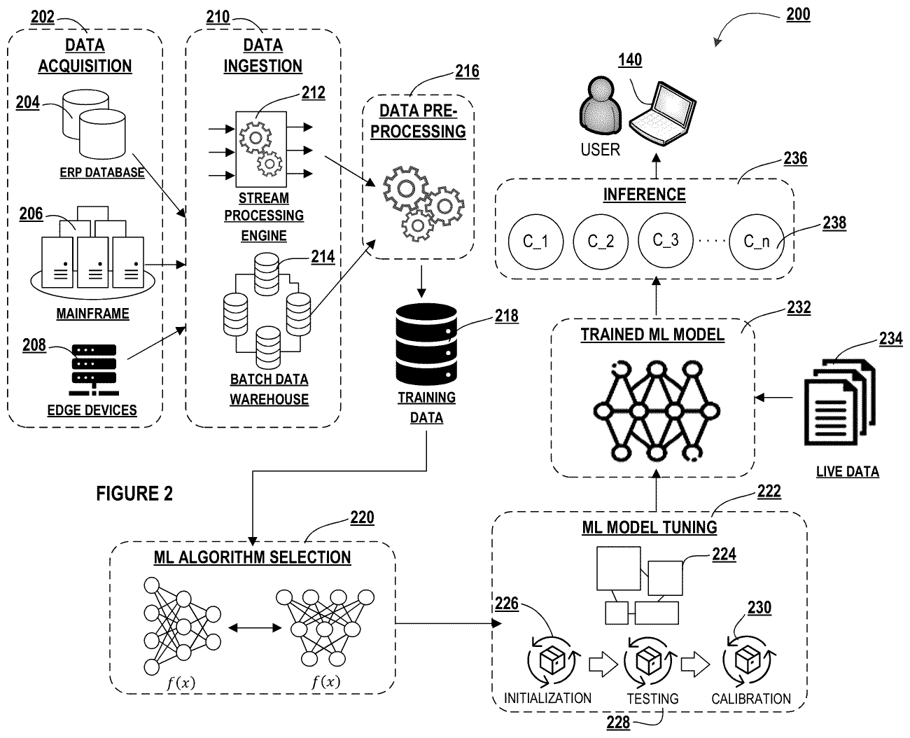

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

The technical operation of the machine learning component within the invention begins with the data pre-processing engine 216. This engine plays a pivotal role in refining and preparing the raw data for effective machine learning application. It applies a series of transformations to the raw data to enhance its quality and utility for learning purposes. For instance, it addresses issues like missing values, noisy data, and inconsistency. This is crucial because the accuracy and reliability of machine learning models depend significantly on the quality of input data. The pre-processing engine also performs feature extraction and selection, a process crucial for handling high-dimensional data. By identifying and isolating the most relevant features from the data, it reduces computational complexity and focuses the learning process on the most informative aspects of the data. This step is particularly important for the invention as it determines the efficiency and effectiveness of the machine learning model in recognizing patterns and anomalies in regulatory and standards across different datasets.

Once the data is pre-processed, it is fed into the ML model tuning engine 222. This engine's primary function is to select and optimize the machine learning model 224 that will be used for compliance checking. This involves choosing the appropriate algorithm from a wide range of available machine learning techniques-such as supervised learning, unsupervised learning, or deep learning-based on the specific requirements of the task. For example, supervised learning may be used for classification tasks where the model needs to categorize API actions as compliant or non-compliant based on labeled training data. In contrast, unsupervised learning could be employed for clustering and pattern recognition in data where explicit labels are not available. The tuning engine also adjusts hyperparameters of the chosen algorithm, running iterative cycles of experimentation, testing, and tuning to refine the model's accuracy. This continuous optimization process is vital for ensuring that the machine learning model remains adaptive and effective in the ever-evolving landscape of financial regulations and standards.

The fully trained machine learning model 232 is deployed via the inference engine 236. This engine utilizes the trained model to make real-time predictions or decisions on new, live data. In the context of the invention, this means analyzing API actions for compliance with current regulatory and standards. The inference engine interprets the model's output, translating it into actionable insights or decisions. For instance, in a supervised learning scenario, it might categorize API actions into compliant or non-compliant based on learned patterns. In unsupervised learning, it could identify novel patterns or anomalies indicative of potential compliance issues. This step is crucial as it represents the application of the machine learning model to practical, real-world scenarios, enabling financial institutions to dynamically ensure API compliance. The categorized outputs or decisions made by the inference engine are then relayed to the user input system for review or further action, completing the cycle of machine learning-driven compliance checking in this invention.

For data handling and processing, in some embodiments, Python is extensively used due to its robust libraries like Pandas, NumPy, and scikit-learn, which are essential for data manipulation, numerical calculations, and machine learning, respectively. In some embodiments, R programming is incorporated for its strong statistical analysis and data visualization capabilities, which are pivotal in the system predictive analysis component. The system may also include a dynamic regulatory database and standards repository, the management of which are facilitated by both SQL and NoSQL databases, such as MySQL, PostgreSQL, and MongoDB, catering to structured and unstructured data needs. In some embodiments, Apache Spark plays a significant role in handling large-scale data processing and real-time analytics, crucial for real-time compliance monitoring. For the more complex tasks like sentiment analysis and predictive modeling, deep learning libraries like TensorFlow or PyTorch may be utilized. Additionally, in some embodiments, Hadoop is employed for distributed storage and processing of the large and diverse datasets from various global regulatory bodies.

The training of the model commences with the collection and integration of data from the Dynamic Regulatory Database and Standards Repository, comprising regulatory texts, guidelines, and historical compliance data. This data is then preprocessed using Python, involving cleaning, normalization, and feature extraction processes. The selection of the machine learning model is a critical step, where a model, such as a Random Forest or Deep Neural Network, is chosen based on the compliance analysis requirements. This model is trained on a divided dataset of training and testing sets, utilizing Python libraries. The performance of the model is fine-tuned through hyperparameter adjustments, validated using the testing set to ensure accuracy.

Once trained, the model is integrated into the system for real-time compliance monitoring. The system analyzes API operations in real-time, using Apache Spark to flag potential breaches efficiently. The model also employs predictive analytics to foresee potential regulatory changes and adapts to region-specific compliance requirements. In some embodiments, automated reporting is another key feature, where the model generates comprehensive reports on compliance status and incorporates a feedback loop for continuous learning and refinement of its algorithms. In preferred embodiments, the system also features a stakeholder notification system and an interactive dashboard that displays comprehensive insights on the compliance status. The customizable rule engine allows for the addition of specific compliance rules by entity, ensuring tailored compliance checks. Sentiment analysis, using advanced deep learning techniques, gauges public opinion and adjusts compliance strategies accordingly.

By integrating these components and processes, the system ensures that entity API offerings are not only at the forefront of technology but also adhere strictly to norms and regulatory standards. This approach effectively mitigates chance of issues while bolstering the entity reputation in the marketplace.

In some embodiments, the system is equipped to monitor current events, particularly those hitting the newswire, which may raise concerns regarding the handling of sensitive data. These events could range from political upheavals to foreign conflicts or other significant social issues. The system achieves this by integrating a real-time news feed aggregator that continuously scans a variety of global news sources. Utilizing advanced text analysis and natural language processing algorithms, the system can identify and extract relevant information from these news feeds. The extracted data is then processed and analyzed to discern any potential impact on data handling practices, especially in scenarios where these events may influence or foreshadow changes in data privacy laws and regulations.

In preferred embodiments, the system actively gathers textual data of regulations from different jurisdictions. This involves the use of web scraping tools and APIs to collect regulatory texts from official government websites and legal databases. The gathered textual data, often diverse in format and structure, is then standardized and stored in a structured format in a centralized database. This standardization is crucial for enabling effective and consistent analysis across different jurisdictions. The system employs machine learning models, specifically designed for text analysis, to parse and interpret the nuances of these regulatory documents. By continuously updating its database with the latest regulations, the system remains adept at identifying and adapting to any changes or trends in regulatory landscapes.

In some embodiments, the system recognizes patterns in regulatory changes occurring across various jurisdictions. For example, the system may identify a trend where certain regions are adopting more stringent data privacy laws. Leveraging predictive analytics, the system extrapolates these patterns to forecast potential regulatory changes in other jurisdictions. This predictive capability is particularly valuable for global entities operating in multiple regions, as it aids in proactive compliance planning. The machine learning algorithms are trained on historical regulatory changes and current event data, enabling them to predict how and when similar changes might occur in different jurisdictions. In other embodiments, the system may recommend that the entity align its data handling practices with the most stringent standards identified across relevant jurisdictions. This recommendation is generated by analyzing the regulatory standards of each jurisdiction where the entity operates and identifying the most rigorous among them. By adopting the highest standard, the entity not only ensures compliance across different regions but also positions itself as a leader in data privacy and handling of data.

In some embodiments, the evolving landscape of regulatory language and sentiment analysis data is utilized to infer best practices for data handling. The system integrates sentiment analysis tools to gauge public opinion and expectations regarding data privacy and standards. By correlating this sentiment data with the trends identified in regulatory texts, the system can provide preemptive recommendations on data handling standards. These recommendations are based on a comprehensive understanding of both the legal landscape and public sentiment, ensuring that the entity's practices are both compliant and publicly acceptable. From a technical standpoint, the data gathered from various channels is processed using a combination of data normalization, entity extraction, and thematic analysis techniques. These techniques transform the raw data into a structured, analyzable format suitable for machine learning and data analysis tools. This processed data is then used to inform the system compliance monitoring and predictive analysis functionalities.

Finally, the processed data and insights generated by the ERCC are reported to end-users through an interactive dashboard. This dashboard provides a comprehensive view of the current compliance status, potential issues, and predictive insights. For API management, the system can automatically integrate these insights into the API development and deployment lifecycle, ensuring that all new and existing APIs adhere to the inferred best practices and regulatory requirements. This integration not only streamlines the compliance process but also embeds a culture of proactive and data handling within the entity's operational framework.

A sophisticated process flow is established to correlate regulatory language with sentiment analysis, thereby generating data handling recommendations. Initially, the system engages in a comprehensive data collection phase, where it acquires regulatory texts from various jurisdictions, focusing on data privacy laws through web scraping tools and APIs. Concurrently, sentiment data regarding data privacy issues is gathered from social media, news outlets, and public forums. This data is then preprocessed for uniformity and clarity, involving steps like normalization, entity extraction, and thematic analysis. An illustrative example involves the analysis of a new European Union data protection law against public sentiment data, where sentiment analysis techniques determine the general public opinion towards such regulations. The core of this process lies in the correlation and analysis stage, where machine learning algorithms, such as regression analysis or neural networks, are employed to discover patterns linking regulatory changes and public sentiment. A specific metric, like sentiment alignment score, is utilized to quantify the alignment between public opinion and regulatory changes. Based on the analysis, the system formulates recommendations. For example, if there is a high sentiment alignment with a new stringent EU law, the system may suggest adopting similar stringent measures, anticipating analogous regulatory shifts globally.

In terms of technical components, the ERCC system integrates Python and R for data processing, alongside SQL/NoSQL databases for storage, and Apache Spark for handling large datasets. The system processes both structured data (e.g., legal documents, or the like) and unstructured data, including social media content. The throughput speed from data collection to the generation and dissemination of recommendations is optimized for rapid response, potentially within hours, depending on the complexity and volume of the data involved. These recommendations are then presented through an interactive dashboard, offering detailed analyses and actionable insights to users. Additionally, for API management, these insights are directly integrated into the API development lifecycle, providing automated compliance checks and alerts, thereby ensuring adherence to both legal standards and public sentiment. This comprehensive, AI-driven approach enables entities to maintain legal compliance and robust public trust by staying ahead of regulatory trends.

Integrating sentiment alignment scores into API management and automatically adjusting API data handling is achieved through a series of sophisticated technical steps. Initially, the system employs Natural Language Processing (NLP) libraries, such as NLTK or spaCy in Python, to perform sentiment analysis on public data. This process involves extracting relevant text, breaking it down (e.g., tokenization), and classifying sentiments as positive, negative, or neutral. In some embodiments, sentiment mapping may correspong to ranges, wherein 80-100% is considered positive, 60-79% is considered neutral, and 0-59% is considered negative, or the like. Concurrently, statistical analysis tools or machine learning models, possibly regression models implemented in Python, correlate these sentiment analysis results with regulatory text data to calculate the sentiment alignment score, typically represented as a percentage. For the practical integration of these insights into the API development lifecycle, a compliance check module is developed within the API framework. This module, which can be coded in Python or JavaScript, is designed to interpret the sentiment alignment score and automatically adjust the API's data handling rules accordingly. For example, if a high alignment with strict data privacy laws is detected, the API's data consent mechanisms might altered to be more stringent. This module is supported by a database system, like MySQL or MongoDB, which stores the rules and thresholds for compliance checks and is updated in real-time with new sentiment alignment scores.

The system also incorporates real-time monitoring scripts within the API, written in languages such as Python or JavaScript, to continuously oversee compliance with the current data handling rules. An alert system is in place to notify developers or compliance officers when potential non-compliance issues are detected, based on the sentiment alignment score. This entire mechanism is integrated into the API's Continuous Integration/Continuous Deployment (CI/CD) pipeline, ensuring that every update to the API is compliant before deployment. In terms of actual changes in API data handling, the API's backend logic, which could be written in Python, Node.js, or Java, includes conditional statements that adapt its data processing based on the current set of rules determined by the latest compliance checks. An API gateway is used to enforce these data handling policies, acting as an intermediary to ensure compliance with the latest rules and standards.

For instance, if a new sentiment alignment score indicates a public shift towards stricter data consent, the compliance check module updates the rules in the database accordingly. The API's real-time monitoring script detects this rule change and automatically adjusts its data handling procedures, such as requiring more explicit user consent for data collection. If any attempt is made to process data in a way that violates the new rules, the alert system promptly notifies relevant personnel, and all changes are tested and deployed through the CI/CD pipeline. This ensures a seamless integration of compliance and public sentiment alignment into the existing API framework, maintaining legal compliance and public trust in an automated and efficient manner.

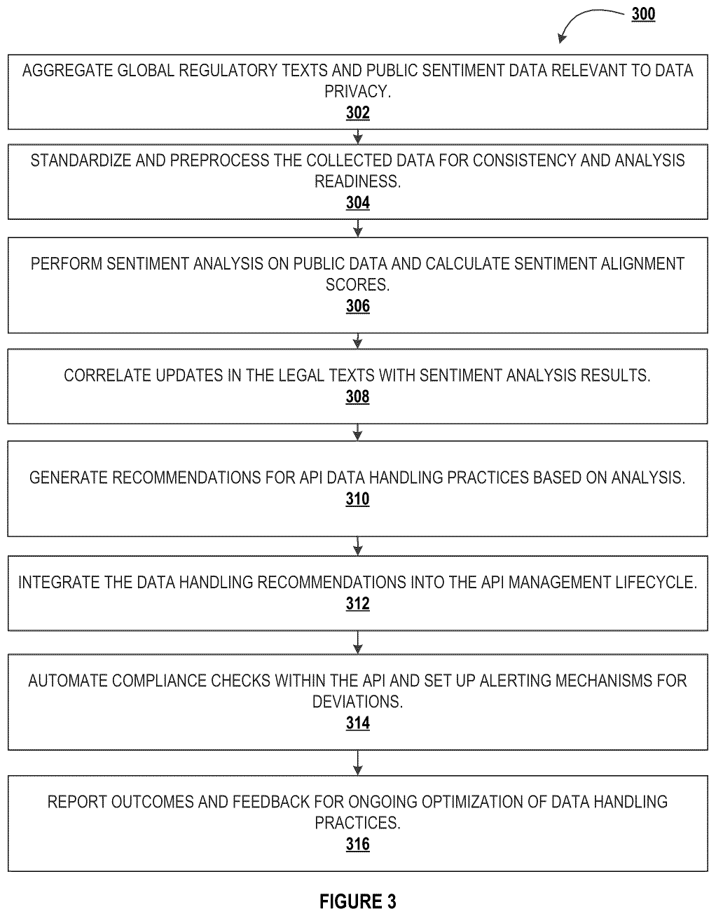

As shown in FIG. 3, the process 300 begins Step 302, wherein the system aggregates global regulatory texts and public sentiment data relevant to data privacy. The system initiates its workflow by aggregating the latest regulatory texts from various global jurisdictions, focusing on data privacy laws and regulations. Concurrently, the system gathers public sentiment data from social media, news articles, and forums, or the like. This step utilizes web scraping tools and APIs to compile a comprehensive dataset that reflects the current landscape and public opinion on data privacy matters. The process continues at Step 304, wherein the system standardizes and preprocess the collected data for consistency and analysis readiness. Once collected, the data undergoes a preprocessing phase where it is standardized, ensuring consistency in format across different data types. In some embodiments, this involves normalization processes to align diverse data structures, entity extraction to identify and categorize important elements, and thematic analysis to detect and organize main topics. The preprocessing step is critical for transforming raw data into a clean, uniform format suitable for detailed analysis.

Continuing at Step 306, the system performs sentiment analysis on public data and calculate sentiment alignment scores. Utilizing NLP techniques, the system performs sentiment analysis on the public data to classify sentiments into categories such as positive, negative, or neutral. It then calculates sentiment alignment scores, which reflect how closely public sentiment aligns with the regulatory texts, or the like. This step employs sophisticated algorithms to analyze and quantify the degree of public support or opposition to current data privacy regulations. At Step 308, the system correlates updates in the legal texts with sentiment analysis results. More specifically, the system correlates the updates in legal texts with the results from sentiment analysis. This involves using machine learning models to identify patterns that link regulatory changes to public sentiment.

The goal is to determine how legal updates are perceived by the public and how these perceptions align with a law's intent and language. At Step 310, the system generates recommendations for API data handling practices based on analysis. Based on the correlation results, the system generates data handling recommendations. These recommendations are informed by the sentiment alignment scores and the detected trends in regulatory changes. The aim is to provide actionable insights that guide how APIs should handle data to ensure compliance with regulations and alignment with public sentiment. As shown in Step 312 the system integrates the data handling recommendations into the API management lifecycle. The system integrates the generated recommendations directly into the API management lifecycle. This involves updating the API's compliance check module and adjusting the API's data handling rules to align with the latest recommendations. This step ensures that the APIs operate in accordance with both current legal requirements and public expectations.

Moving further to Step 314 the system automates compliance checks within the API and set up alerting mechanisms for deviations. Automated scripts continuously monitor the API's data handling against the updated recommendations. If potential non-compliance or deviations from best practices are detected, the system triggers alerts. These alerts notify the relevant stakeholders within the organization, prompting them to take corrective actions. The final step, Step 316, includes generating report outcomes and feedback for ongoing optimization of data handling practices. This final step involves reporting the outcomes of the compliance checks and integrating feedback into the system. This feedback loop allows for ongoing optimization of the API's data handling practices. The system records the effectiveness of the implemented recommendations and uses this information to refine future analysis, ensuring that the API's data handling remains up-to-date with the evolving legal landscape and public sentiment.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for advanced algorithmic compliance integration in API frameworks, the system comprising:
a processing device;
a non-transitory storage device containing instructions when executed by the processing device, causes the processing device to perform the steps of:
retrieve, via data acquisition engine, data from multiple sources, wherein the data comprises a subset of regulatory text data and a subset of public sentiment data;
standardize and preprocess the data, generating structured analysis data;
perform, via a machine learning engine, a sentiment analysis on the subset of public sentiment data;
based on the sentiment analysis, calculate a sentiment alignment score, wherein the sentiment alignment score comprises a percentage value representing alignment between the subset of regulatory test data and the subset of public sentiment data;
retrieve, via the data acquisition engine, updated regulatory text data and historical regulatory text data;
analyze, via the machine learning engine, the updated regulatory text data and the historical regulatory text data and determine a change to a requirement; and
generate a recommendation for an API data handling practice based on both the sentiment alignment score and the change to the requirement.

2. The system of claim 1, wherein the data acquisition engine comprises a stream processing engine for continuous data processing and a batch data warehouse for scheduled data transfer.

3. The system of claim 1, wherein the standardizing and the preprocessing of data further comprises data normalization, entity extraction, and thematic analysis.

4. The system of claim 1, wherein the sentiment analysis and the calculation of sentiment alignment score are performed using Natural Language Processing (NLP) libraries.

5. The system of claim 1, wherein the system is further configured to:
identify a most stringent standard between multiple regions;
and generate a recommendation for the API data handling practice aligning with the most stringent standard.

6. The system of claim 1, wherein the recommendation for the API data handling practice further comprises updating an API compliance check module and adjusting an API data handling rule.

7. The system of claim 1, wherein the system is further configured to: transmit the recommendation for the API data handling practice via an interactive dashboard displaying one or more compliance insights.

8. A computer program product for advanced algorithmic compliance integration in API frameworks, the computer program product comprising a non-transitory computer-readable medium comprising code causing an apparatus to:
retrieve, via data acquisition engine, data from multiple sources, wherein the data comprises a subset of regulatory text data and a subset of public sentiment data;
standardize and preprocess the data, generating structured analysis data;
perform, via a machine learning engine, a sentiment analysis on the subset of public sentiment data;
based on the sentiment analysis, calculate a sentiment alignment score, wherein the sentiment alignment score comprises a percentage value representing alignment between the subset of regulatory test data and the subset of public sentiment data;
retrieve, via the data acquisition engine, updated regulatory text data and historical regulatory text data;
analyze, via the machine learning engine, the updated regulatory text data and the historical regulatory text data and determine a change to a requirement; and
generate a recommendation for an API data handling practice based on both the sentiment alignment score and the change to the requirement.

9. The computer program product of claim 8, wherein the data acquisition engine comprises a stream processing engine for continuous data processing and a batch data warehouse for scheduled data transfer.

10. The computer program product of claim 8, wherein the standardizing and the preprocessing of data further comprises data normalization, entity extraction, and thematic analysis.

11. The computer program product of claim 8, wherein the sentiment analysis and the calculation of sentiment alignment score are performed using Natural Language Processing (NLP) libraries.

12. The computer program product of claim 8, wherein the code further causes the apparatus to:
identify a most stringent standard between multiple regions;
and generate a recommendation for the API data handling practice aligning with the most stringent standard.

13. The computer program product of claim 8, wherein the recommendation for the API data handling practice further comprises updating an API compliance check module and adjusting an API data handling rule.

14. The computer program product of claim 8, wherein the code further causes the apparatus to: transmit the recommendation for the API data handling practice via an interactive dashboard displaying one or more compliance insights.

15. A method for advanced algorithmic compliance integration in API frameworks, the method comprising:
retrieve, via data acquisition engine, data from multiple sources, wherein the data comprises a subset of regulatory text data and a subset of public sentiment data;
standardize and preprocess the data, generating structured analysis data;
perform, via a machine learning engine, a sentiment analysis on the subset of public sentiment data;
based on the sentiment analysis, calculate a sentiment alignment score, wherein the sentiment alignment score comprises a percentage value representing alignment between the subset of regulatory test data and the subset of public sentiment data;
retrieve, via the data acquisition engine, updated regulatory text data and historical regulatory text data;
analyze, via the machine learning engine, the updated regulatory text data and the historical regulatory text data and determine a change to a requirement; and
generate a recommendation for an API data handling practice based on both the sentiment alignment score and the change to the requirement.

16. The method of claim 15, wherein the data acquisition engine comprises a stream processing engine for continuous data processing and a batch data warehouse for scheduled data transfer.

17. The method of claim 15, wherein the standardizing and the preprocessing of data further comprises data normalization, entity extraction, and thematic analysis.

18. The method of claim 15, wherein the sentiment analysis and the calculation of sentiment alignment score are performed using Natural Language Processing (NLP) libraries.

19. The method of claim 15, wherein the method further comprises:
identify a most stringent standard between multiple regions;
and generate a recommendation for the API data handling practice aligning with the most stringent standard.

20. The method of claim 15, wherein the method further comprises: transmit the recommendation for the API data handling practice via an interactive dashboard displaying one or more compliance insights.
